(19) United States
(12) Patent Application Publication
(10) Pub. No.: US 2010/0223146 A1
(43) Pub. Date: Sep. 2, 2010

(54) Method of Effecting Cashless Payments and a System for Implementing the Method

(75) Inventor: Mathias Entenmann, Richmond (GB)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Reston, VA (US)

(21) Appl. No.: 12/647,061

(22) Filed: Dec. 24, 2009

Related U.S. Application Data
(63) Continuation of application No. 09/678,295, filed on Oct. 2, 2000.

(51) Int. Cl. G06Q 20/00; G06Q 30/00; H04W 4/12

(52) U.S. Cl. 705/17; 455/466

(57) ABSTRACT

The object of the present invention is to provide a method for simple but secure cashless payment, especially at different locations, and a system for implementing the method. In the method according to the invention an amount of money is read in at a merchant station and transmitted to a comparing device together with an-identification code of the merchant station, the data being stored in the interim at the comparing device. The payer sends the identification code of the merchant station through a mobile cell phone to the comparing device, which compares the identification code with that of the stored data and transmits the corresponding amount of money to the cell phone. Confirmation of the payment is requested there and transmitted to the comparing device, which transmits a corresponding account entry to an account keeping device. The system for implementing the method includes a cell phone, which operates in cell phone network, a merchant station and a comparing device, which can be connected to the cell phone and the merchant station through telecommunications and/or data links.

This application is continuation of application Ser. No. 09/678,295, filed Oct. 2, 2000, which is incorporated herein by reference in its entirety.

1. Field of the Invention

This invention relates to a method of effecting cashless payments and a system for implementing the method.

2. Background

Cashless payment commerce has increased greatly in recent years for various reasons. Among these, purchases no longer have to carry large amounts of cash with them, in order to be able to make big purchases, so that for one thing the risk of theft is reduced and for the other impulse purchases become possible. For the vendor, the handling of large cash sums is obviated.

The simplest means of payment of this kind, the check, is however not very secure, since checks are easily stolen and can be used improperly for example after forging the signature. Moreover their use is troublesome for the purchaser and the merchant.

Accordingly, among other things, credit cards have been introduced, with which the cardholder having a valid credit card can “pay” through his signature in combination with the number of the credit card, or often with only the number. The risk of misuse is high here also, since no strong security mechanisms are included. In addition to the signature, an authorization center is often called up by the merchant, so that he can ascertain whether or not the card is stopped.

On account of the high fees and the fact that a credit card holder must always have been granted a certain amount of credit, smart cards, which at present are also sometimes called cash cards, have been developed. Encryption technology is used in these chip cards, in order to be able to store amounts of money in the card so that the card can only be charged up by authorized institutions. In order to payout larger amounts, a PIN is provided, which is checked directly from the chip card on payment. This kind of payment requires a not inconsiderable outlay, since a network of charging stations has to be set up. Moreover the merchants have to acquire corresponding reading stations.

In patent application WO 98/47116 there is described a method of effecting payments by a customer to a merchant by means of telecommunication devices, as well as corresponding apparatus for implementing the method. In this method the customer firstly establishes a mobile cell phone connection to a so-called telepay device through a cell phone. This device then calls over the established connection for a merchant identification code and an amount to pay. The telepay device stores this transaction data in the interim and sends requests for confirmation to the customer and to the merchant—after setting up a suitable communication link and transmission of a transaction code specific to this transaction and the amount to be confirmed. After reception of confirmation the amount is transferred from a bank specified by a customer entry to a data-bank of the telepay device to a bank specified by a merchant input, or the first bank is instructed to effect the transfer. For security the geographic position of the mobile cell phone is determined either by determination of the radio cell in which the telephone is located, or by GPS and compared with a list or allowed locations. This method is in the first place technically complex in relation to the determination of location and secondly the customer has to provide a comparatively large amount of information over the cell phone, which cab tedious and prone to error on account of the mostly small keys and display. Moreover no further data regarding the transaction, e.g. the purpose of the payment or the like, can be entered simply.

### SUMMARY

The object of the present invention is therefore to provide a method which is simple, especially for the customer, but secure, for cashless payment, especially at different locations, and a system for implementing the method. As to the customer, the progressing of the transaction is to be effected by means of a simple confirmation, e.g. by PIN entry, without complex information entry or other operating steps being required. In addition as little new infrastructure as possible (hardware or software) is to be required both on the merchant side and on the customer side and in the most favorable case the present day equipment with point of sale terminal devices should suffice.

This object is met by a method with the features of claim 1, which can be implemented by a system with the features of claim 18.

In contrast to the use of credit cards, it is not possible for the merchant to use for later transactions the data exchanged during the connection because of the required mobile cell phone connection of limited duration and the entry of the confirmation during this time.

Furthermore it is possible to effect the payment by use of the comparing device, without the data relevant to security of the customer reaching the merchant. To this extent the method allows anonymous payment.

Furthermore purchasers who already have a mobile cell phone with a SIM card can perform the method very simply and cheaply. A particular advantage of the method lies in that mobile cell phones with SIM cards are already very widespread so that a large user base can pay by the method according to the invention without further investment or PINs to be remembered.

In addition the merchant station is technically very simple, since in the simplest case an electronic till with an online payment facility is sufficient on the merchant side for carrying out the invention. Likewise computers with modems and suitable software for example can serve as merchant stations. Furthermore a second mobile cell phone is suitable as a simple merchant station. Thus a simple and secure cashless payment is possible.

Moreover, although there is frequently spatial proximity between the merchant station and the mobile cell phone this is not necessary.

Furthermore, the customer no longer has to enter the amount to be paid himself. The method according to the invention has this advantage over the method according to WO/47116, since the price of goods is as a rule acquired today at the till automatically from the price ticket or using a barcode or other characterization read by a reader connected to the till, so that repeated acquisition of the purchase price can be avoided.

The object is further met by a method and a system for implementing the method with the features according to claims 3 and 19 respectively.

Except for the advantage of anonymous payment, the second method has the same advantages as the first method; moreover there is the advantage that the entries by the mobile cell phone user are minimal, since he is called.

However, in contrast to the first method, the identification code associated with the SIM card does get to the merchant.

The object is further met by a method and a system for implementing the method with the features according to claims 6 and 20 respectively.

The expression “interface for wireless data transmission” also embraces, as it does generally in this application, also corresponding devices for processing data, i.e. reading out of a memory and transmission or reception and writing into a memory. Special software adapted to the merchant station or the mobile cell phone can be included in this. The wireless transmission can be effected by various media, e.g. light in the infrared or visible region, micro or radio waves or even ultrasound. When using micro or radio waves “BLUETOOTH” is especially preferred as the interface. Practically non-directional transmission is then possible, requiring no visible contact between the mobile cell phone of the customer and the merchant station. When using light, an IrDA or AIr interface is preferred as the interface, where the transmission is effected by infrared radiation in a restricted spatial angular range using a specific protocol, which on the one hand reduces interference and on the other reduces the scope for manipulation.

As well as the advantages of the first method, the advantage of this method is that the manufacturer does not need to learn any kind of data from the purchaser while at the same time the purchaser does not have to enter the data of the merchant himself.

In the first and second methods it can be necessary to read in the identification code of the comparing device in the first step. However the identification code of the comparing device can be stored, so that when only one comparing device is involved, a connection is made to this automatically on the basis of the stored identification code, or—when several comparing devices are involved—it is only necessary to select one from among those stored.

Preferred embodiments of the method and of the system for implementing the method are characterized in the dependent claims 2, 4, 5, 7-17 and 21 and 22.

Cell phones are to be understood in this application as including combinations of cell phones with other electronic apparatuses, such as electronic notebooks or generally terminal devices in a mobile radio network with a telephone component. However an essential feature is that the apparatus can only be operated using a SIM card, which is preferably protected by a PIN. SIM cards are to be understood generally as so-called system or subscriber identification module cards, on which are stored the data necessary for a cell phone connection, especially the details identifying the terminal and which are to be entered in the cell phone in order to be able to operate it in the corresponding network. This preferably involves apparatuses according to the GSM standard but other standards can also be used, which employ encrypted transmission of data and protection of the mobile cell phone access through data stored in the form of a SIM card for example and preferably further using access control through a PIN. In general in this application by a mobile cell phone with a SIM card characterized by an identification code denoting it are further understood such mobile radio terminal apparatuses which comprise fixed, built-in components with the abovementioned function of a SIM card, i.e. in which the details needed for a cell phone connections are stored, especially the data identifying the terminal.

In the simplest case the identification code associated with or identifying the SIM card can comprise the telephone number of the cell phone. In a further embodiment however another identification code determined by the user of the telephone can be used, e.g. identification code of the network operator and a unique identification code in the domain of the network operator such as the account number with the network operator.

Especially in the first and third methods, identification codes are preferred in each case which are stored in the SIM card and are automatically transmitted. Confirmations or establishment of a connection in the third embodiment can then only be effected over a connection made to this SIM card, which substantially increases the security, since in the first place passwords alone are very easily misused and in the second place using the identification code without the SIM card is not readily possible because of the automatic call for or transmission of an identification code stored in the SIM card, and SIM cards with their content are not easy to forge. By using a mobile cell phone with such a SIM card only the holder of the SIM card can provide the confirmation for the payment from an account associated with the SIM card. Further security lies on that mobile cell phones with a SIM card are usually protected by a PIN stored on the SIM card, which is to be entered when initiating use.

Since mobile radio connections cannot be intercepted, or only with very great difficulty, manipulation of the radio connection is more or less ruled out.

The data which is to be output can equally be effected by speech output or in the form of graphical or text communications, which can for example be shown on the display of the cell phone. The comparing device must transmit the data in a suitable form to the cell phone for this.

Data, especially the confirmation information, can be entered in the cell phone by speech, for which the comparing device must have a speech recognition device, or the form of key presses, which are decoded differently. Thus the information can also be entered by the multi-frequency tone (touch tone) method or by SMS service through keys of the mobile cell phone.

The display of the information and the input of data can in particular be menu-controlled, if the comparing device and the mobile cell phone are adapted for this. Preferably also for graphically presented menus use can be made of for example WAP (wireless applications protocol), also the HTT or XC protocol (where no connection is made to the Internet however).

In addition it is possible to combine the confirmation information with further security queries, such as for example passwords, PIN's, a Secure ID card, biometric tests such as finger print tests, speech or speaker recognition or other security devices.

The merchant station comprises an input and an output device as well as an interface for connection to comparing devices and is identified by an identification code. For the data connections to the comparing devices pure data links can be used but any other suitable kind of telecommunications connection can also be used. The interfaces are then designed accordingly. In particular the merchant station can be a station which can make mobile cell phone connections and in the simplest case it is also simply a mobile cell phone.

Instead of transmitting the identification code of the merchant station, it is also possible in a preferred embodiment to transmit the name and location of the merchant station to the cell phone and to output it there, after reading out the name and location of the merchant station on the basis of the merchant station identification code from a table stored in the comparing device.

In the first and second methods the connection of the merchant station to the comparing device can be permanent or be made before or only after input of the appropriate information. This step is then considered to be part of the first transmission step from the merchant station to the comparing device. In the latter case the connection between the comparing device and merchant station is broken again after transmission of the confirmation information, which is considered as part of the transmission step to the merchant apparatus.

If no connection to the cell phone is made in the first or second solution, the transaction is broken off. In this case a suitable code is preferably sent to the merchant station, where a corresponding message is issued.

In a preferred embodiment of the first or second method the merchant can also easily transmit the reason for the transaction or supplementary information therewith to the comparing device. In particular, when articles are recognized by article references in conjunction with an article data bank, e.g. through article numbers and/or corresponding barcodes, the merchant can very easily transmit this data together with the amount to be paid to the comparing device, which this then passes on to the customer. This would not be readily possible in a method such as in WO/9847116, which starts out from a cell phone.

In a preferred embodiment of the first and second methods and the corresponding systems, the cell phone and the merchant station have interfaces through which identification codes can be transmitted from one apparatus to the other by wireless means. Instead of input of the identification codes the corresponding identification code can be transmitted by the interface from one apparatus to the other, at the latest in the step in which otherwise an identification code would be entered manually. In the case of the first method the merchant can transmit through this interface not only his identification code but-also further supplementary information on the transaction to the cell phone, so that the customer does not have to make any further inputs, i.e. merchant identification code, amount, etc.

The interfaces for the wireless data transmission can be of analog form as in the third method, only the processing of the data being suitably modified.

The IR interface in the cell phone is so designed that the identification code of the SIM card can be output through the interface by a key-press on the phone and/or an identification code can be read in through the IR interface, stored and can be sent during an existing telephone connection on a key-press, if desired together with the identification code of the SIM card. Corresponding memory and calling functions are preferably also present in the merchant station.

In a particularly preferred embodiment of the third method and of the system adapted to implement it, the merchant station and cell phone are so designed that both the identification code of the merchant station and also further information, especially the amount of money, are transmitted from the merchant station to the cell phone by the wireless connection, especially an IR connection, and can be stored there temporarily. Furthermore the cell phone is so designed that the stored data can be accessed and transmitted while the connection exists. In the third method only the identification code of the SIM card then needs to be entered.

The comparing device includes interface devices for data connections to the merchant stations and also for mobile radio links as well as further merchant and subscriber checking devices for checking the identification codes from merchant stations and SIM cards authorised for this service, a transaction memory device for storing open transactions, a connection to an account keeping device and a control device which oversees all processing steps and the control over the individual devices.

The comparing device also has an identification code identifying it, in the simplest case a telephone number or an IP address.

The interface devices involve devices through which a connection to a corresponding subscriber can be made and operated. Depending on the network employed they can be simple analog operating modulator/demodulators, but with digital networks however other, digitally operating interface devices are used.

The comparing device comprises subscriber and merchant checking devices, with the aid of which it is possible to check whether a subscriber or a merchant station is authorised for the method. This can involve subscriber or merchant memory devices, in which are stored at least the identification codes of the SIM cards and the merchant stations authorised for this service. In the simplest case these can be simple files or data banks in which further information associated with an identification code can also be stored.

In a preferred embodiment the identification code of a SIM card and the account number for the account keeping device associated therewith is stored in each case in the subscriber memory device. If the identification code of the SIM card is not its telephone number, this is also stored with the identification code. The control device then transmits to the account keeping device not the identification code of the SIM card but the account number corresponding to the identification code, on the basis of the information in the subscriber memory device.

Correspondingly the identification code of a merchant station and the account number associated therewith for the account keeping device can be stored in the merchant memory device. The control device then transmits to the account keeping device not the identification code of the merchant station but account identifying data corresponding to the identification code, in Germany for example the account number and bank code number, on the basis of the information in the merchant memory device. This applies correspondingly to the subscriber memory device.

The account keeping device can be integrated with the comparing device in a preferred embodiment, which allows a compact construction and very rapid processing of the transaction data with little interference.

As to the transaction data, in the method this involves the amount of money and the merchant station identification code for example, and in the second and third methods the subscriber identification code as well.

In a further preferred embodiment of the first method or the system for implementing the first method, an open transaction is stored only for a certain time. If there is no confirmation within this time, the open transaction is cancelled and the merchant station involved in this open transaction is informed that the transaction has been abandoned. Thus closeness in time of the individual connections is necessary, as a further security measure.

In a further preferred embodiment the cell phone network and the comparing device are so designed that the comparing device can determine the telephone number of the SIM card of the calling mobile cell phone and its telephone number is used as an identification code for the SIM card. In this case the entry of the identification code of the SIM card in the mobile cell phone in the various variant methods can be dispensed with and instead the telephone number of the SIM card is always determined in the comparing device. At the same time, in the first and third methods, this then ensures that only the holder of the SIM card can confirm the transaction.

The comparing device is preferably so designed that manual intervention by operator personnel is possible to deal with method errors.

The merchant station and the comparing device are preferably so designed that they can perform several of the various method variants.

As well as the arrangement described above the necessary data or telephone communication networks must also be present, in order to be able to carry out the method. In this sense they are also components of the system for implementing the method.

The methods according to the invention can also be used to particular advantage to effect payments over the Internet, since spatial proximity between the cell phone and the merchant device does not have to exist—or in this case the computer used for the Internet connection is to be regarded as part of the merchant device.

### BRIEF DESCRIPTION OF THE DRAWINGS

Embodiments of the invention will now be described with reference to the drawings, in which:

FIG. 1 is a schematic representation of a system according to one embodiment of the invention,

FIG. 2 is a schematic representation of a merchant station of the system according to FIG. 1,

FIG. 3 is a schematic representation of the comparing device in FIG. 1,

FIGS. 4a and 4b show a greatly simplified schematic representation of a method according to one embodiment of the first method according to the invention,

FIGS. 5a and 5b show a greatly simplified schematic representation of a method according to one embodiment of the second method according to the invention, and

FIG. 6 shows a greatly simplified schematic representation of a method according to one embodiment of the third method according to the invention.

### DETAILED DESCRIPTION

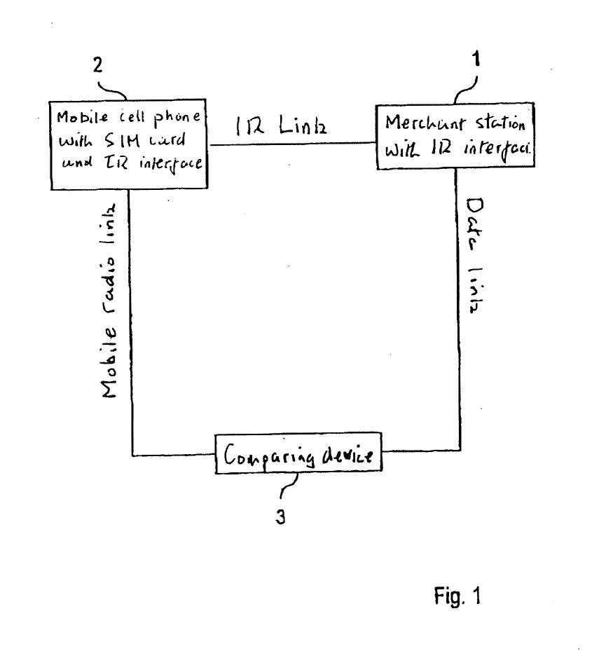

In FIG. 1 a system according to a first embodiment of the invention includes a mobile cell phone 2 with a SIM card and an IR interface, a merchant station 1 with an IR interface and a comparing device 3. The identification code of the mobile cell phone can be transmitted from the phone to the merchant station via an IR link between their IR interfaces.

The comparing device 3 can be connected to the mobile cell phone 2 through a mobile radio link and to the merchant station 1 through a data link.

The three devices, merchant station 1, comparing device 3 and mobile cell phone 2. or more precisely the SIM card therein, have identification codes identifying them, which are in the present embodiment the telephone numbers of the merchant station, the comparing device and the mobile cell phone. However IP addresses for example could be used instead of the telephone numbers.

The mobile cell phone 2 includes a SIM card for a given telephone network,—as is known per se and usual—which has to be activated by input of a PIN, as well as an IR interface well known per se for data interchange. It is so therefore arranged that it can transmit the data transmitted and stored through the IR interface, on a request therefor during an existing telephone connection. It is activated to implement the method in the corresponding mobile radio network.

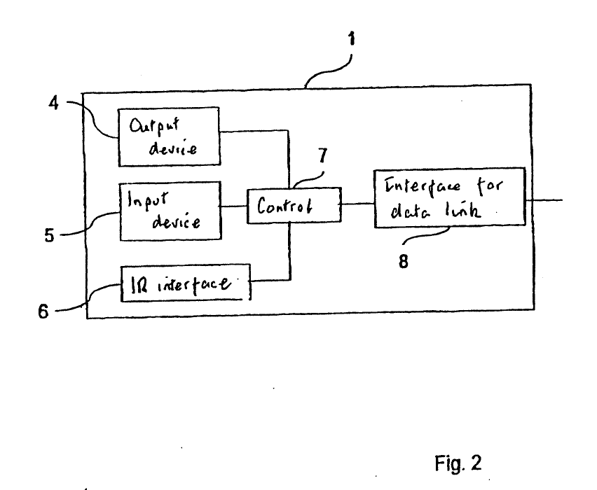

In FIG. 2 the merchant station 2 comprises an input device 5, e.g. a keyboard, an output device 4, e.g. a display device such as a monitor for example, and an infrared interface 6, which is so designed that a data exchange with the cell phone is possible through it, as well as an interface 8 for a data link. A control device 7 is connected to the other devices and processes the inputs, issues data to be displayed to the output device 4 and receives or transmits data over the IR interface 6 and/or the data interface 8 in dependence on inputs from the input device 5 or the other interfaces.

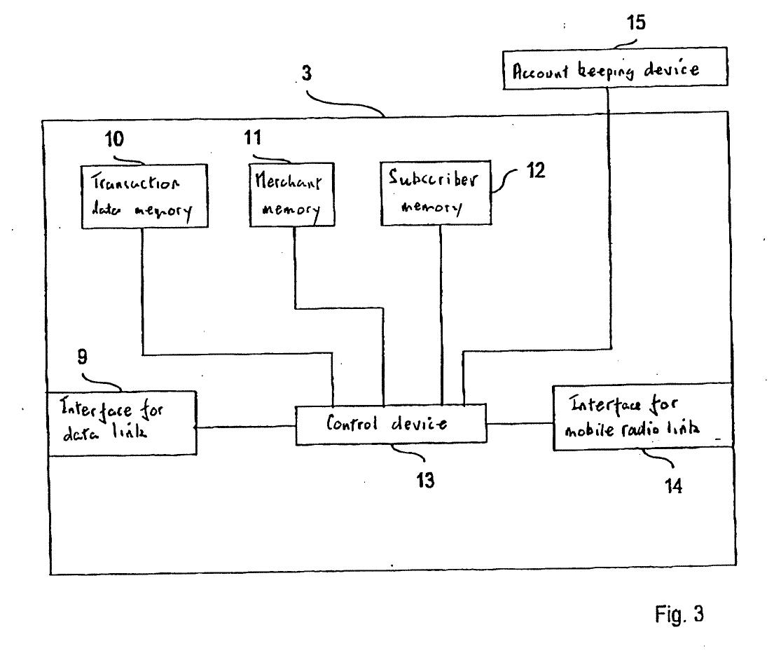

The comparing device 3 in FIG. 3 includes and interface device 9 for data connections to merchant stations and an interface device 14 for mobile radio links, a transaction data memory 10 for temporary storage of transaction data, a merchant checking device in the form of a merchant memory device 11 for storing merchant identification codes and corresponding account numbers, a subscriber checking device in the form of a subscriber memory device 12 for storing subscriber identification codes and corresponding account numbers, a connection to an account keeping device 15, and a control device 13 for processing and exchanging data of the abovementioned devices of the comparing device. In the simplest case this can be a PC or other computer with suitable telecommunications interface cards and corresponding software.

The control devices 7 and 13 of the merchant station and the comparing device respectively are so designed that they perform the steps of the payment process. Different forms of the control device arise, depending on the method.

The course of a payment transaction according to an embodiment of the first method is shown in the following.

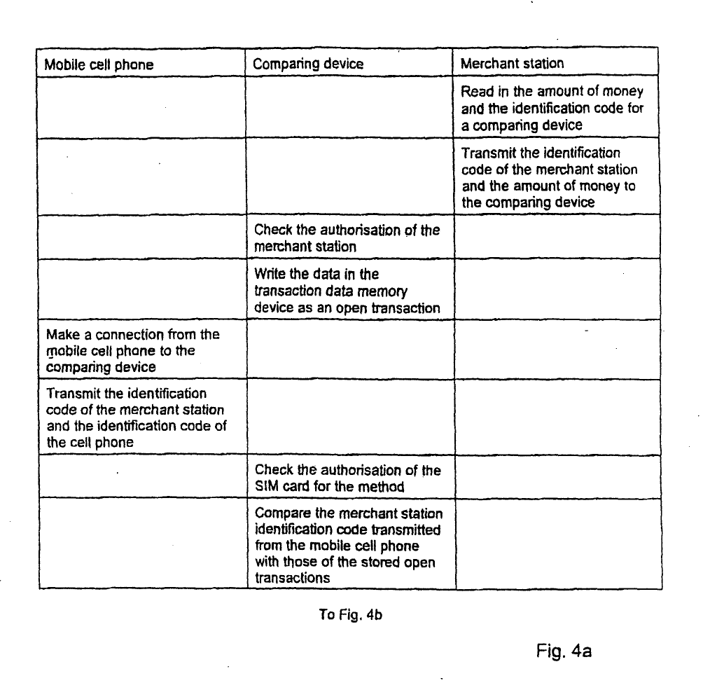

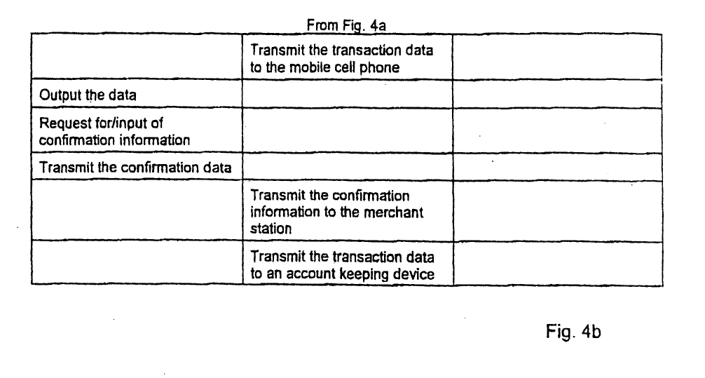

FIGS. 4a and 4b show a rough summary of the course of the method in tabular form, wherein the sequentially following method steps in the individual system components of mobile cell phone 2, comparing device 3 and merchant station 1 are shown one below the other in corresponding columns.

In essence an amount of money and a merchant identification code are transmitted from the merchant station 1 to the comparing device 3 and stored there in the interim after checking the merchant identification code. The merchant identification code is read in from the mobile cell phone 2, before or after making a connection to the comparing device 3, depending on the design of the cell phone; this can also be effected by speech input and this code is transmitted together with the identification code of the SIM card to the comparing device, where the identification code of the SIM card is checked. By comparing the merchant station identification code with those in the temporarily stored data the amount of money to be transferred is determined, sent to the mobile cell phone 2 and output there. After input of confirmation information this is transmitted to the comparing device 3, which sends the data to the merchant station 1 and transmits the data to an account keeping device 15 in dependence on the confirmation information.

In detail the method according to this embodiment proceeds as follows:

Initially an amount of money to be payed and the identification code for the comparing device 3 are entered into the merchant station 1 through the input device 5, whereupon the identification code for the merchant station 1 and the amount of money are transmitted as transaction data to the 5 comparing device 3 with this identification code, by means of the controller 7, after making a data connection to the comparing device 3 through the data connection interface 8 and the data connection.

The data are received in the comparing device 3 through the interface 9 for the data connection.

After comparing the merchant identification code with the merchant identification codes entered in the merchant memory 11 to check the legitimacy of this merchant station for the service, the transaction data is written by the control device 13 in the transaction data memory device 10 of the comparing device, as an open transaction. Before input of the data to the merchant station 1 or at the latest after making the connection to the comparing device 3, the identification code, i.e. the telephone number of the merchant station is transmitted through the infrared interface 6 to the cell phone 2. A connection is made from the mobile cell phone 2 to the comparing device 3 and the stored identification code of the merchant station 1 and the identification code of the cell phone are transmitted to the comparing device 3. Should the transmission over the infrared interfaces temporarily fail to function, the identification code can also be entered through the keypad. This input can thus also be effected when using a cell phone without an IR interface.

The merchant station identification code transmitted from the mobile cell phone 2 is compared in the comparing device 3 with the merchant identification codes of the open transactions stored in the transaction data memory device 10. If such a transaction is not found the process is terminated, otherwise the transaction data which is located is transmitted via the mobile radio interface to the mobile cell phone and is output there. Furthermore the identification code of the mobile cell phone is compared with the subscriber identification codes entered in the subscriber memory 12, in order to determine whether the subscriber is permitted to use the service. If such permission does not exist the transaction is terminated and corresponding data are sent to the merchant station 1.

After a request for and entry of confirmation information through the keyboard of the mobile cell phone 2, the confirmation data are transmitted to the comparing device 3, which in turn transmits the confirmation information to the merchant station 1, where it is output.

A check is made in the control device 13 of the comparing device 3 as to whether the confirmation data correspond to a refusal or not. In the first case the transaction is terminated, in the second case the transaction data are read out of the transaction data memory 10, the identification codes of the merchant station and of the mobile cell phone are converted into account numbers on the basis of the data in the merchant and transaction data memories and the transaction data now with account number is passed to an account keeping device 15. The transaction is cleared from the transaction data memory 10.

A constant check is made in the comparing device 3 as to how long open transactions persist in the transaction data memory 10. If a predetermined time limit for an open transaction is exceeded, data is sent to the corresponding merchant station 1, to show that the transaction has been denied and the open transaction is cleared from the transaction data memory 10.

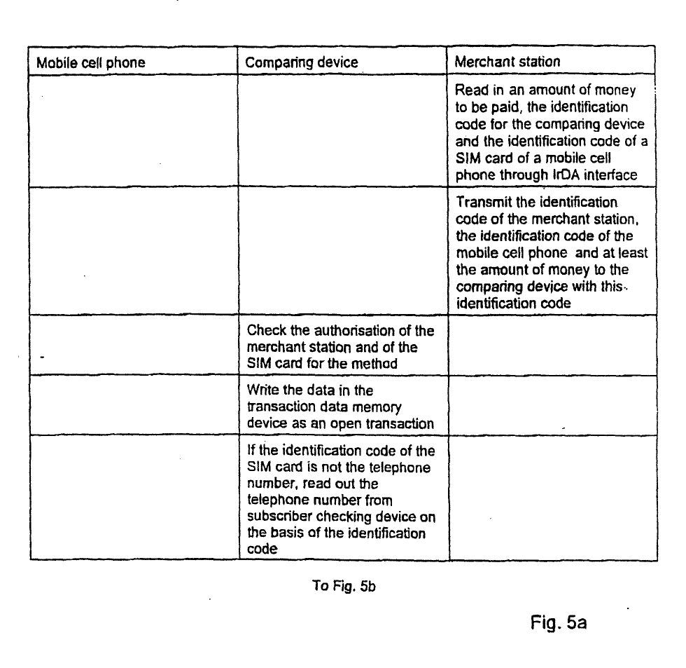

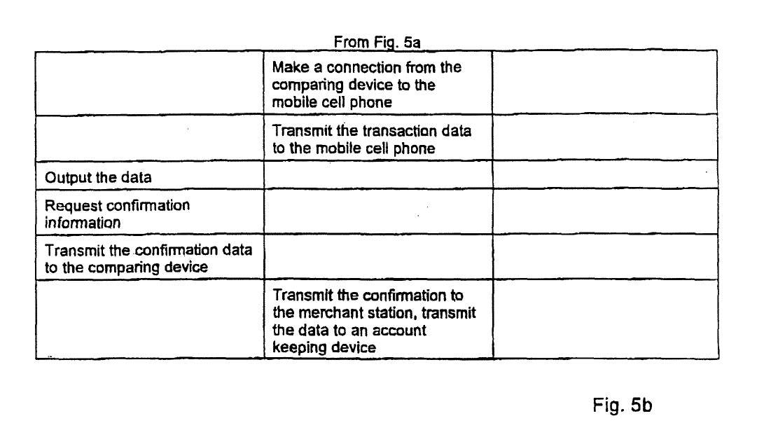

The course of a payment transaction according to an embodiment of the second method is shown in tabular form in FIGS. 5a and 5b, as a rough summary, wherein the sequential method steps in the individual system components of mobile cell phone, comparing device and merchant station are set out under one another in corresponding columns.

In essence the amount of money and the identification code of the merchant station 1 are read in, also the identification code of the SIM card via an IR interface 6, and transmitted to the comparing device 3. After checking the merchant identification code and the identification code of the SIM card, this produces a connection to the cell phone 2 on the basis of the identification code of the SIM card and transmits the data, which are output from the cell phone 2. After entry of confirmation information and transmission to the comparing device 3 the confirmation information is transmitted to the merchant station I and the transaction data to the account keeping device 15.

In detail, the method according to this embodiment proceeds as follows:

As to the corresponding devices for performing the method, the schematic showings in FIGS. 1 to 3 apply again, however the control devices 7 and 13 corresponding to the modified method have a different mode of operation.

At the merchant station 1 the amount of money to be paid, the identification code for the comparing device 3 and the identification code of the mobile cell phone 2, entered through the infrared interface 6, are read into the merchant station. After making the data link to the comparing device 3 the identification code of the merchant station, the identification code of the mobile cell phone and the amount of money are transmitted as transaction data to the comparing device.

The data is received in the comparing device through the interface 9 for data links. The identification codes of the merchant station and of the SIM card are compared with the identification codes in the merchant memory 11 and subscriber memory 12 respectively, in order to determine whether the merchant and subscriber are authorised to participate in this service. In the absence of either of the authorizations corresponding data is sent to the merchant station 1 and the transaction is terminated. Otherwise the data of the open transaction is written in the transaction data memory 10. On the basis of the identification code of the SIM card a connection is made from the comparing device to the mobile cell phone 2 and the transaction data is transmitted to the mobile cell phone, where the data is output through the mobile cell phone. If no connection can be made the transaction is terminated.

Confirmation information is requested through the mobile cell phone 2 and the confirmation data which is entered is transmitted to the comparing device 3.

The comparing device 3 terminates the transaction if the confirmation data corresponds to a refusal or there is no reply.

The confirmation information and optionally further transaction information are is transmitted at the merchant station 1, while a termination is transmitted as a refusal. The reason for termination can optionally also be transmitted. The transmission of the transaction data is effected as in the first method.

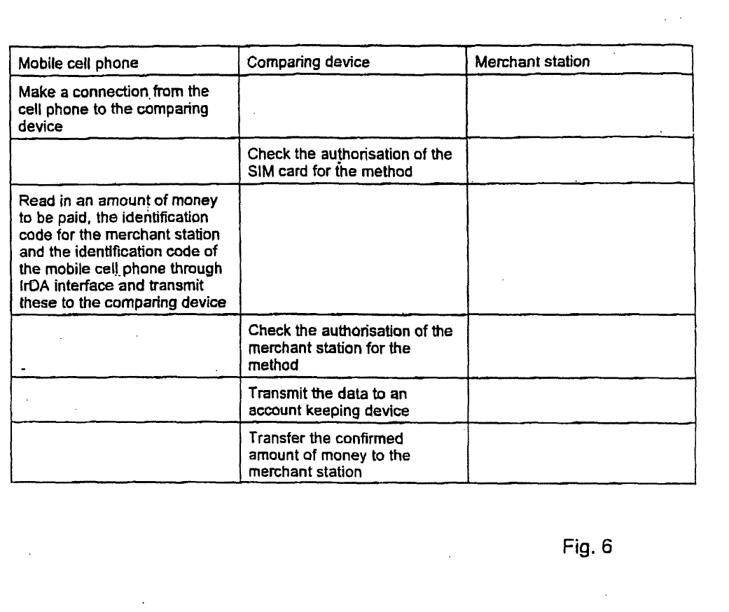

The course of a payment transaction according to an embodiment of the third method is shown in FIG. 6 in tabular form, as a rough summary, wherein the sequential method steps in the individual system components of mobile cell phone, comparing device and merchant station are set out under one another in corresponding columns.

In essence the identification code of the merchant station 1 is entered in the mobile cell phone 2, a connection to the comparing device 3 is made and the identification code of the merchant station 1 and that of the SIM card, as well as the amount of money entered through the mobile cell phone 2 are transmitted to the comparing device 3. After checking the identification codes this transmits at least the amount of money to the merchant station and corresponding transaction data to an account keeping device.

In detail the method according to this embodiment proceeds as follows:

The schematic showings of FIGS. 1 to 3 again apply to the appropriate devices for performing the method, where however the control devices 7 and 13 have a different mode of operation corresponding to the modified method. Initially the identification code of the merchant station is initially transmitted from the merchant station 1 via the IR connection to the cell phone and is stored there temporarily. A connection is then made to the comparing device 3 through the cell phone 2.

The amount of money to be paid is then read in through the cell phone 2 and the identification code for the merchant station 1 and the identification code of the SIM card are transmitted to the comparing device. The comparing device 3 checks whether the merchant station 1 and the SIM card are registered for the service. on the basis of the merchant memory 11 and the subscriber memory 13. If this is not the case, the transaction is terminated. otherwise the account numbers are determined from the identification codes of the merchant station and the mobile cell phone or the SIM card from the merchant and subscriber memories respectively and these account numbers as well as the amount of money are passed on to the account keeping device 15.

The confirmed amount of money is then transmitted to the merchant station 1.

What is claimed is:

1. A method for cashless payment transactions, comprising:
receiving at a gateway a request message from a merchant station, the merchant station associated with a merchant and the request message (a) indicative of a cashless payment transaction involving the merchant and a user of a mobile cell phone and (b) including at least an identifier of the merchant station, an identifier of the mobile cell phone, and a transaction amount;
performing one or more processing steps including at least (a) validating the merchant based on the identifier of the merchant station, (b) validating the user of the mobile cell phone based on the identifier of the mobile cell phone, and (c) preserving aspects of the cashless payment transaction as an open transaction in transaction memory;
generating a notification message to the user of the mobile cell phone, the notification message containing at least (a) the identifier of the merchant station and (b) the transaction amount;
receiving a reply message from the user of the mobile cell phone, the reply message containing at least an indicator from the user of the mobile cell phone signifying acceptance or rejection of the cashless payment transaction; and
advancing the cashless payment transaction responsive to the indicator signifying acceptance or terminating the cashless payment transaction, and purging the open transaction from transaction memory, responsive to the indicator signifying rejection.

2. The method of claim 1, wherein, based on the transaction amount, funds belonging to the user of the mobile cell phone sufficient for the cashless payment transaction are confirmed during the one or more processing steps.

3. The method of claim 1, further comprising:
generating a confirmation message to the user of the mobile cell phone.

4. The method of claim 1, further comprising:
generating a confirmation message to the merchant station.

5. The method of claim 1, wherein the notification message and the reply message are each conveyed through one of (a) a wireless messaging paradigm or (b) infrared communication.

6. The method of claim 5, wherein the wireless messaging paradigm is one of (a) Unstructured Supplementary Service Data or (b) Short Message Service.

7. A system for cashless payment transactions, comprising:
a gateway at which a request message is received from a merchant station, the merchant station associated with a merchant and the request message (a) indicative of a cashless payment transaction involving the merchant and a user of a mobile cell phone and (b) including at least an identifier of the merchant station, an identifier of the mobile cell phone, and a transaction amount; a comparing device capable of:
(a) (i) validating the merchant based on the identifier of the merchant station, (ii) validating the user of the mobile cell phone based on the identifier of the mobile cell phone, and (iii) preserving aspects of the cashless payment transaction in transaction memory;
(b) generating a notification message to the user of the mobile cell phone, the notification message containing at least (i) the identifier of the merchant station and (ii) the transaction amount;
(c) receiving a reply message from the user of the mobile cell phone, the reply message containing at least an indicator from the user of the mobile cell phone of acceptance or rejection of the cashless payment transaction; and
(d) advancing the cashless payment transaction responsive to the indicator signifying acceptance and terminating the cashless payment transaction responsive to the indicator signifying rejection.

8. The system of claim 7, the comparing device further capable of:
generating a confirmation message to the user of the mobile cell phone.

9. The system of claim 7, the comparing device further capable of:
generating a confirmation message to the merchant station

10. The system of claim 7, wherein the notification message and the reply message are each conveyed through one of (a) a wireless messaging paradigm or (b) infrared communication.

11. The system of claim 7, wherein the wireless messaging paradigm is one of (a) Unstructured Supplementary Service Data or (b) Short Message Service.
